(19) United States
(12) Patent Application Publication
(10) Pub. No.: US 2010/0125364 A1
(43) Pub. Date: May 20, 2010

(54) CONFIGURABLE CONSUMABLE HOLDER FOR AN APPLIANCE

(75) Inventors: MATTHEW P. EBROM, Holland, MI (US); MICHAEL S. HENDRICKSON, Saint Joseph, MI (US); JOEL A. LUCKMAN, Benton Harbor, MI (US); RICHARD A. MCCOY, Stevensville, MI (US); RICHARD A. SUNSHINE, Granger, IN (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, Benton Harbor, MI (US)

(21) Appl. No.: 12/274,429

(22) Filed: Nov. 20, 2008

(51) Int. Cl. G01M 1/38; G05D 7/00

(52) U.S. Cl. 700/275; 700/283

(57) ABSTRACT

A removably coupled consumable holder for an appliance configured to perform a cycle of operation on a physical article comprises a receptacle sized to hold one or more compartments for holding a consumable. The compartments are connected with an array of actuators for controlling the delivery of the consumable from the compartment to the appliance. A controller is connected with the array of actuators for actuation of the actuators during a cycle of operation. The consumable holder is further connected with an internal communications network in the appliance for communication with one or more components of the appliance.

### BACKGROUND OF THE INVENTION

The invention relates generally to a removably coupled consumable holder for an appliance configured to perform a cycle of operation on a physical article.

### SUMMARY OF THE INVENTION

In accord with the invention, a removably coupled consumable holder for an appliance configured to perform a cycle of operation on a physical article comprises a receptacle sized to hold one or more compartments for holding a consumable. The compartments are connected with an array of actuators for controlling the delivery of the consumable from the compartment to the appliance. A controller is connected with the array of actuators for actuation of the actuators during a cycle of operation.

In one aspect, the consumable holder can also be connected with an internal appliance network that communicably connects the consumable holder with one or more components in the appliance or connected with the appliance. The consumable holder can also use the internal appliance network to communicate information about itself and its contents to other components in the appliance or connected with the appliance.

In another aspect of the invention, the controller is configured to determine information about the consumables or the configuration of the compartments within the consumable holder and convey the information to the appliance to affect a cycle of operation. Preferably, the controller is able to determine the configuration of the consumable holder and identify the actuators to be controlled in the actuator array.

### BRIEF DESCRIPTION OF THE DRAWINGS

In the drawings:

FIG. 1 illustrates an appliance with a removably coupled consumable holder according to an embodiment of the invention.

FIG. 1A illustrates an appliance with a removably coupled consumable holder according to another embodiment of the invention.

FIG. 2 is a schematic view of a removably coupled consumable holder according to another embodiment of the invention.

FIG. 2A is a schematic view of a removably coupled consumable holder according to another embodiment of the invention.

FIGS. 3A and 3B illustrate an example of a configuration of a removably coupled consumable holder according to an embodiment of the invention.

FIG. 4 illustrates an example of a configuration of a removably coupled consumable holder according to another embodiment of the invention.

### DESCRIPTION OF EMBODIMENTS OF THE INVENTION

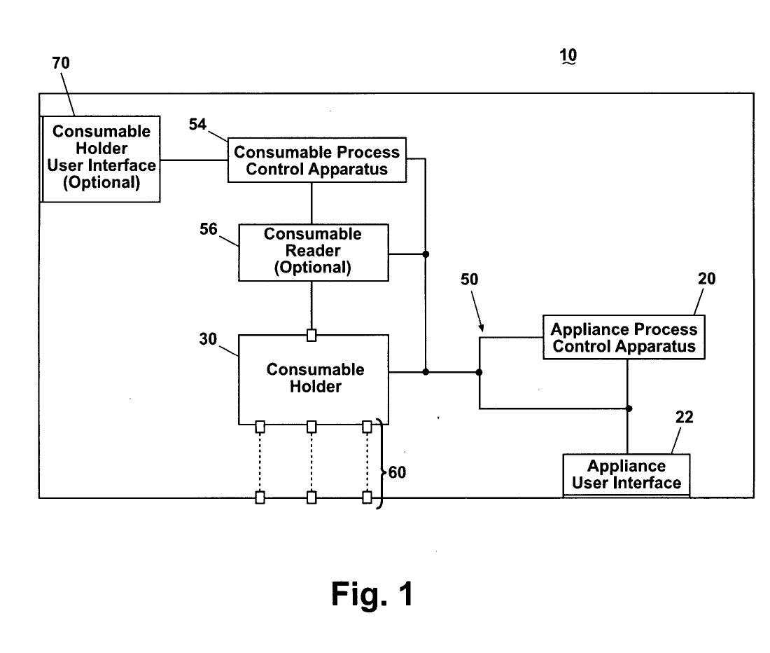

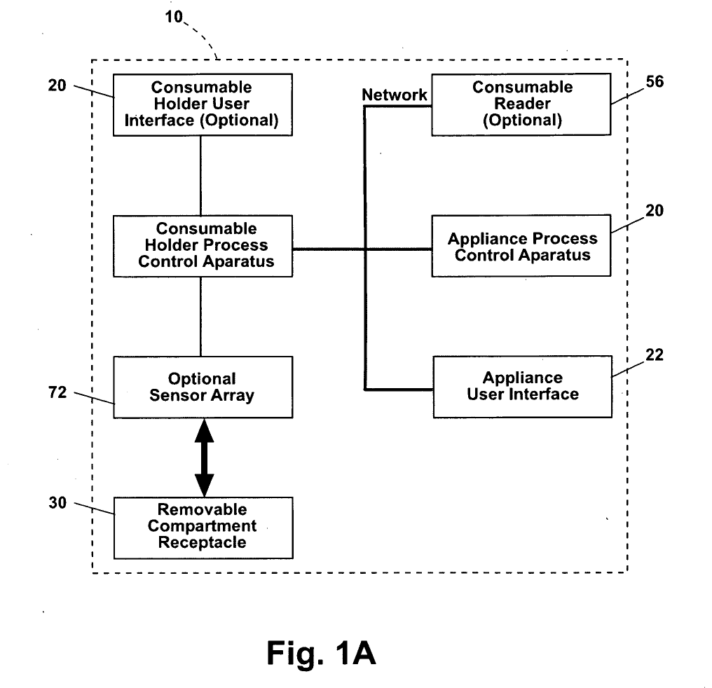

Referring now to the figures, FIG. 1 illustrates an appliance 10 according to the invention that is configured to perform an operation on a physical article, such as clothing or food, using a resource such as water, temperature-controlled air (hot or cold), steam, gas, electricity, and the like. The appliance 10 has an appliance process control apparatus 20, a user interface 22 and a removable consumable holder 30. The process control apparatus 20 is configured to implement and control a cycle comprising at least one operation. The process control apparatus 20 can comprise one or more components, such as electronic control boards, wiring and wiring harnesses, power-supplies, sensors integrated with the electronics as digital or analog inputs, and actuators like valves, relays, heaters, and the like, any or all of which can integrate with the electronics as digital or analog outputs. The process control apparatus can also be in an accessory to the appliance 10, including, for example, the consumable holder 30, as long as the appliance has access to it. Examples of appliances 10 that perform an operation on a physical article include a wide range of device types, including but not limited to, washers, dryers, ovens, ranges, steam cookers, ice makers, refrigerators, drink makers and the like.

The consumable holder 30 is configured to hold, carry, supply, communicate with, or otherwise interact directly with a consumable, and can be internal to or external to the appliance 10. When performing a cycle of operation on an article, the appliance 10 will often use at least one consumable. A consumable in one sense comprises a substance, device, or other product that would be at least partially consumed or transformed by an appliance during a cycle of operation on an article, such that the consumable must be periodically replaced or replenished. The period after which the consumable must be replaced or replenished can be but is not limited to a single cycle of operation, multiple cycles of operation, an amount of time, or a number of uses. For example, many common washing machines require that a user place a single dose of detergent in a dispenser prior to initiating a cycle of operation. For each subsequent cycle of operation, the user must again place a single dose in the dispenser, as a single dose of detergent is consumed by the washing machine during each cycle of operation.

In some cases, the consumable can be the article on which the appliance 10 performs the cycle of operation, and the consumable can be subsequently consumed by a user. Thus, a consumable also includes anything that would be consumed or otherwise used by a person, such as food, beverages, cosmetics, or medicine. For example, in a cooking or refrigeration appliance, the consumable can be a food item, and the cycle of operation comprises heating or cooling the food.

Consumables are to be distinguished from resources, although resources may in some circumstances be “consumed” during a cycle of operation. Resources are fluid or gas commodities that are continuously available to an appliance, and used by the appliance in its cycles of operation on articles. Typical examples as mentioned above would include water and air. In some cases, a resource may also be considered an article as in a refrigerator that chills and dispenses water. Water in that instance is a resource (continuously available to the refrigerator), but also an article (intended by the user for the refrigerator to act upon). The cycles of operation would include the chilling and dispensing. Things that hold or supply resources such as water supply lines or air conduits are not considered consumable holders 30. They would be “resource holders”, which can be supplied by resource providers. In a refrigerator, for example, water supplied to the appliance 10 would be considered a resource and/or an article. If flavoring is mixed with the water supplied to the appliance 10, the flavoring can be considered a consumable, and whatever holds/supplies the flavoring to be the consumable holder 30.

Consumables are also to be distinguished from parts in an appliance, although parts wear out and need to be replaced or replenished as do consumables. Parts are devices, without which a cycle of operation by the appliance or a principal function of the appliance would be hampered. Examples include valves, other types of actuators, switches, tubes, lamps, wiring, motors, pumps, seals, gears and the like. Consumables, on the other hand, are not critical to the operation of the appliance, although they provide huge benefits to a user of the appliance. An appliance can typically still operate on an article in some fashion without a consumable.

The user interface 22 can include indicators like LEDs, buzzers, light rings, segmented displays, or graphics on a graphical LCD. The user interface 22 can be a programmable user interface such as a PDA, web tablet, a cell phone, an LCD attached to the appliance 10. The user interface 22 can have any suitable form, such as a monitor, including a touch panel monitor. Other examples of the user interface 22 can include, but are not limited, to a remote keypad, a phone, a personal computer, a voice recognition device, a voice generation device, a sound generation and recognition device, a remote control, a user interface of a home automation system, a user interface of a component different from the components of the appliance, a television, a device that plays recorded music, a device that plays recorded video, and a personal digital assistant.

The appliance 10 can further include an internal appliance network 50, communicably coupling the appliance process control apparatus 20, the user interface 22, the removable consumable holder 30 and any other controllable components of appliance 10.

An appliance performing a cycle of operation on an article will often use at least one consumable during the cycle. Non-limiting examples of a cycle of operation include a clothes washing cycle in laundry washer, a de-wrinkle cycle in a clothes dryer, and dispensing of water from a water dispenser in a refrigerator. Examples of the use of a consumable in an appliance include dispensing additives for laundry washers, dryers, or combination washer/dryer appliances, dishwashers and refrigerators. The additives for use in a laundry washer or dryer or a dishwasher can include, but are not limited to, normal detergents, gentle detergents, dark clothing detergents, cold water detergents, fabric softeners, chlorine bleaches, color-safe bleaches, and fabric enhancement chemistry. Non-limiting examples of fabric enhancers are additives to provide stain resistance, wrinkle resistance, water repellency, insect repellency, color fastness, fragrances, and anti-microbials. An example of a consumable for use with a refrigerator is a flavor additive for drinking water, such as might be added to drinking water dispensed from a refrigerator. Another example of consumables contemplated by the invention includes filters used by an appliance. Refrigerators, dryers, washers, and dishwashers are all known to use filters.

The consumable holder 30 can be coupled with its own consumable process control apparatus 54 and to the internal appliance network 50 to control dispensing of one or more consumables from the consumable holder 30. Thus the consumable holder 30 can be controlled by and /or control the appliance process control apparatus 20 to affect the cycle of operation, and/or its own consumable process control apparatus 54 to affect the cycle of operation. The consumable process control apparatus 54 can be configured to direct or modify functionalities of an appliance or be controlled by an appliance. The consumable process control apparatus 54 has a mechanism to effect acting on one or more resources and consumables, such as an actuator to actuate a valve. The consumable process control apparatus 54 can send information to and receive and store information from the consumable holder 30. The consumable process control apparatus 54 is also able to control the dispensing of the consumables from the consumable holder 30 to the appliance 10. In addition, the consumable process control apparatus 54 is in communication with the appliance process control apparatus 20 through the internal appliance network 50. The consumable process control apparatus 54 and the appliance process control apparatus 20 can communicate through the internal appliance network 50 to control the use of consumables and appliance resources to complete a cycle of operation on a physical article. Examples of appliance resources include electricity, gas, air, steam, water, and gray water. The consumable process control apparatus 54 can be separate from the appliance process control apparatus 20 as illustrated in FIG. 1 or it can integrated with another controller in the appliance.

The appliance 10 has at least one coupling point 60 to accommodate coupling a removable consumable holder 30 with the appliance 10. The coupling is configured to enable removable coupling of a consumable holder 30 with the appliance 10. The coupling need not be physical, but can also be electrical or even wireless. Each coupling point 60 can enable a different function. For example, coupling points can facilitate conveying a resource to the consumable holder 30, conveying the resource back to the appliance 10, exchanging data between the appliance 10 and the consumable holder 30, conveying a consumable to the appliance 10, and coupling a circuit with the consumable holder 30. The consumable holder can take resources from the host appliance, act on the resources, and return the changed resources to the appliance. For example, clean water can come in, grey water out, or clean water in and clean water mixed with detergent out. The consumable holder can also dispense the consumable to the appliance. In combination, the consumable holder can export changed consumables which have either been operated on by the consumable holder or been operated on by the introduction of at least one resource.

The appliance can also include coupling points outside of the appliance 10 for external coupling with a consumable holder 30 or with other components that can facilitate engagement with a consumable holder 30. One of the external coupling points can serve as a source when connected to receive a consumable from outside the consumable holder 30, such as a bottle, an open lid in a dispenser, or piping from another source external to the consumable holder 30.

The appliance 10 can also include a coupling point to deliver power to the removable consumable holder 30 and to trigger an actuator in the consumable holder 30 or in the appliance. Such a coupling point can be a power connection adapted to transmit power to a consumable holder, whether the power be in the form of conventional AC at 110 V, or 12 volts DC, or even less, as might be transmitted for example by a USB connection.

The consumable holder 30 can also be coupled with an external communicating device such as a consumable reader 56. The consumable reader 56 is a component that can accept the information associated with the consumable and transmit it to the appliance process control apparatus 20 or the consumable process control apparatus 54. The consumable reader can be a device integrated with the appliance or a separate device that can be coupled, either by a hardwire connection or wireless connection, to the appliance for communication with the appliance. Examples of consumable readers include, but are not limited to, bar code scanners, radio frequency identification (RFID) tag readers, and magnetic strip readers. The consumable reader 56 can be located either inside or outside the main housing of the appliance 10.

It is within the scope of the invention to utilize the consumables without the consumable reader. For example, the consumable can be configured to directly communicate with the appliance or other component on the internal appliance network 50 without employing an intermediate consumable reader.

The consumable holder 30 can also be coupled with an optional client with an arbitrary software component configured to deliver a cycle of operation to an appliance. The client can comprise electronics enabling communication with the consumable process control apparatus 54 or other components of the appliance 10 connected with the internal appliance network 50. The client can store a relational database to provide the appliance 10 and the user with instructions and information regarding the use of consumables in a cycle of operation. The memory of the client can also comprise a relational database linking the model of the appliance 10 to the plurality of consumables that the consumable holder 30 can contain and the plurality of cycles for the appliance 10 to the plurality of cycle modification or cycle operation data linked to the combination of appliance, consumable and selected cycle. Some or all of the software components can also be comprised within one or more other components of the appliance 10, such as the consumable process control apparatus 54 or the appliance process control apparatus 20, for example.

The information associated with the consumable can be in any suitable form. In one embodiment, the information can be a communication packet that can be directly transmitted to the software architecture, thereby eliminating a need for a central storage of consumables data. In another embodiment, the information can be a key that can be used to direct the appliance 10 to stored consumables data.

The consumable holder 30 also comprises a software architecture that enables facile communication between internal components of the appliance 10 and between an external component and one or more of the internal components of the appliance. Various components and accessories can communicate with the appliance 10 to expand the capability, functionality, and usability of the appliance 10, and particularly, an appliance 10 that uses a consumable product during its operation, or otherwise operates on a consumable product.

The software architecture can be implemented on and communicated over the internal communication network 50 on the appliance 10. The internal communication network 50 connects the various internal components of the appliance and can be considered a closed network. One example of the internal communications network used within the appliance is the WIDE network protocol, created by Whirlpool, Inc., the assignee of the present patent application.

The software architecture expands the communication ability of the appliance by effectively creating an open network, hereinafter referred to as “network.” Within the appliance, the software architecture can, but does not have to, reside on each of the components that have a controller. Those components with the software architecture form a network node that can communicate with the other nodes.

The software architecture can perform multiple functions. For example, one function can relate to identifying each of the components corresponding to a node on the network, while another function can relate to identifying capabilities or functions of the identified components on the network. Yet another exemplary function is to identify the status of the components on the network. In this way, the software architecture can function to inform all of the nodes on the network of the presence, capabilities, and status of the other nodes.

The software architecture can comprise multiple modules, each of which has different functionality. Various combinations of the modules or all of the modules can reside on each of the components. One module having a basic or core functionality resides on all of the components. In one anticipated configuration, all of the modules reside at least on a main controller, which establishes the main controller to function as a primary or main software architecture, with the other nodes functioning in a client relationship to the main software architecture. In such a configuration, all of the nodes can communicate through the main software architecture. The software architecture can be sufficiently robust that it can permit configurations without a main software architecture or with multiple main software architectures. For example, the controllers of the various components can work together to control the operation of the appliance without any one of the controllers functioning as a main controller. Regardless of the configuration, any component with the software architecture can function as a client with respect to the other components.

The software architecture can be any suitable software architecture that enables communication between the internal components of the appliance and the external component and/or the new internal component or between components external to the appliance. An example of the software architecture is disclosed in Patent Cooperation Treaty Patent Application No. PCT/US2006/022420, titled “SOFTWARE ARCHITECTURE SYSTEM AND METHOD FOR COMMUNICATION WITH, AND MANAGEMENT OF, AT LEAST ONE COMPONENT WITHIN A HOUSEHOLD APPLIANCE,” filed Jun. 8, 2006, and incorporated herein by reference in its entirety, as published in WO2006135726. All of the communications between components and accessories and/or any combination of components and accessories described in this application can be implemented by the software and network structures disclosed in either of these applications.

The software architecture disclosed in the aforementioned references can be implemented by providing one or more of the software elements of the software architecture at least on each of the components to be controlled and on the accessory. The software architecture is configured to generate a plurality of messages, with at least one of the software elements residing in each of the components and in the accessory and configured to enable transmission of at least one of the plurality of messages between the components and between the accessory and the components. The messages can be transmitted for bidirectional communication between components and/or components and accessory. The messages can include command messages that are used to implement a physical domestic operation cycle of the appliance.

The messages can be generated by a message generator, which can take the form of the software architecture, the accessory, or a component. One possible message generator is a user interface. The appliance user interface 22 and the optional consumable holder user interface 70 can be used individually or in combination to generate messages.

FIG. 1A illustrates another embodiment where the network 50 is configured differently. Here the appliance user interface 22, the appliance process control apparatus 20 and an optional consumable reader 56 are connected on one side of the network 50 to the consumable process control apparatus 54 on the other side of the network 50. The consumable process control apparatus 54 is, in turn connected to the consumable holder user interface, is there is one, and/or to a sensor array 72, if there is one, and installed in a removable compartment receptacle serving as the consumable holder 30. The sensor 72 (as explained further below) can be used in conjunction with the user interface 22 to provide information about such things as compartment configuration, how to actuate each compartment, the type of consumable, the dose volume for a small, medium, & large loads for a washer, different concentrations of consumables, when in cycle to dose, how much consumable remains in each compartment, and the like.

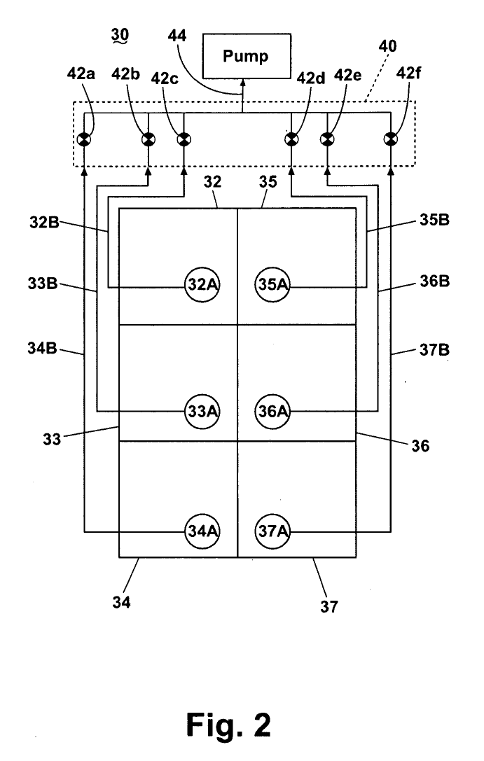

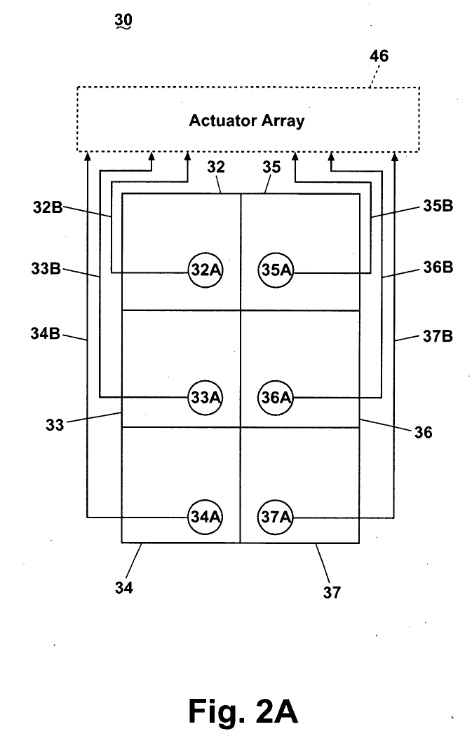

FIG. 2 is a schematic view of a removably coupled consumable holder 30 according to an embodiment of the invention. The removable consumable holder 30 has a plurality of consumable compartments 32-37 for receiving a consumable material. Each of the consumable compartments 32-37 has a corresponding port 32a-37a fluidly connected with a valve 42a-42f in an actuator array 40 through tubes 32b-37b. The actuator array 40 can be rotating shaft or aperture driven by a stepper motor. The actuator array 40 can be connected with a conduit 44 that is in fluid communication with the appliance 10. The actuation of the valves 42 in actuator array 40 can be controlled by the consumable process control apparatus 54.

The appliance 10 can have one or more receptacles. And each receptacle can have multiple compartments. At least one of the compartments should have consumable capacity for multiple cycles.

The configuration of the compartments 32-37 can be altered by the appliance user in a variety of ways. Compartment configuration in a receptacle may be changeable, fixed, or some fixed, some removable. Walls defining each compartment can be moved. Or one or more compartments 32-37 can be a separate package or cartridge received in the consumable holder as a receptacle. At least one of the compartments 32-37 preferably has the capacity for holding enough consumable for multiple cycles of operation. One or more of the compartments can be filled with a liquid consumable by the user. Or, a solid consumable can be inserted in one or more compartments where some or the entire solid can be dispensed by flowing water into the compartment and through the port and actuator.

The consumable holder 30 is removable from the appliance and can include a fixed portion and a removable portion. Consumable holder 30 can be fully removed from the appliance 10 or only partially removed, maintaining a physical and/or electrical connection. For example, consumable holder 30 can be located within a sliding drawer of the appliance 10. The drawer can be selectively slid in or out by the user to provide access to the consumable holder 30. The fixed portion of the consumable holder 30 can include the consumable process control apparatus 54, sensors and actuators, the interface to the appliance 10 and external or internal coupling points. The consumable compartments 32-37 can be removed from the consumable holder 30 and replaced with compartments comprising other shapes and sizes in addition to the square shape illustrated in FIG. 2. For example, compartments 32 and 33 can be removed and replaced with a single compartment that spans the entire space previously occupied by the compartments 32 and 33. The source of a consumable in consumable holder 30 can be a removable cartridge or package designed to fit into a compartment in the consumable holder 30, a reservoir located within a compartment of the consumable holder 30 or external to the consumable holder 30, or a connection to another dispenser.

Preferably, the receptacles and each of the compartments can be cleaned in a sink or dishwasher without adverse effects. Some or all of the consumable compartments may be fixed in the receptacle, and some or all of the consumable compartments may be removed and replaced with compartments for other consumables. The appliance process control apparatus 22 and/or the consumable process control apparatus 54 is notified when the receptacle or a compartment is removed. Upon notice of removal, the appliance process control apparatus 22 or the consumable process control apparatus 54 can initiate a maintenance operation, such as flushing the conduit. Similarly, the appliance process control apparatus 22 and/or the consumable process control apparatus 54 is notified when the receptacle or a compartment is replaced in the appliance. With discovery messaging as set forth below, the configuration can be determined each time a process control apparatus 22, 54 is notified that the receptacle has been replaced.

FIG. 2A is a schematic view of a similar removably coupled consumable holder 30 according to an embodiment of the invention. Here, the actuator array 46 comprises a plurality of micro-machined or active polymer pumps, one of which can be associated with each port.

The consumable holder 30 is able to discover how the user has configured the compartments each time the compartments are removed and replaced. The software architecture described above allows the components of the appliance 10 on the internal communications network 50 to send discovery messages and discovery confirmation messages. The consumable process control apparatus 54 can send a discovery message to the consumable holder 30 comprising at least some query information specifying what information the consumable process control apparatus is seeking. The information sought can be information such as another node on the appliance network 50, an appliance, a client, an arbitrary software component, a device comprising a node, a coupler, or one or more of a plurality of software elements on any node. The consumable holder 30 sends a discovery confirmation message in reply to the discovery message of the consumable process control apparatus 54. The discovery reply message comprises confirmation information and identification information. The confirmation information is an acknowledgment in the form of a positive or a negative response. The identification information is information enabling the sender to send subsequent messages to that which has been discovered. The consumable process control apparatus 54 uses this information to determine how many compartments contain a consumable, how they are configured and which actuators are to control in the actuator array. This information can also be communicated to the appliance process control apparatus over the internal appliance network.

The discovery process can be initiated on a predetermined schedule, when certain criteria are met or by the user. For example, the discovery process can be conducted each time the appliance is turned on or each time a cycle of operation is selected. The discovery process can also be initiated based on sensor input that, for example, senses when a compartment is removed, when a consumable is removed or placed in a compartment or when the consumable holder has been removed from or moved relative to the appliance (e.g. if the consumable holder 30 is located within a drawer that selectively slides in and out of the appliance housing). An example of a suitable sensor is an optical sensor that can sense the physical structure of a compartment, such as the presence or absence of a compartment, for example. Suitable optical sensors include, absorption/transmission spectroscopy, total internal reflection spectroscopy, and index of refraction. Electrical sensors, such as capacitive/impedance or active NTC sensors can also be used. Another example is a mechanical sensor that can sense a mechanical feature on a compartment, such as a microswitch that senses the presence or absence of a protrusion on the compartment, for example. The user can also initiate the discovery process through the user interface on the appliance or on the consumable holder.

The consumable holder 30 is also able to determine the general nature of the consumable in each of the compartments 32-37, including type, quantity and concentration, for example. The information can be determined automatically by sensors located within or externally to the consumable holder 30. Examples of suitable sensors include: optical sensors (e.g. sensors capable of measuring absorption/transmission, index of refraction and total internal reflection of the consumable); mechanical sensing of a mechanical feature within the compartments 32-37 (e.g. a microswitch capable of sensing the presence or absence of a protrusion on a consumable cartridge placed within one of the compartments 32-37); and electrical (e.g. sensors capable of measuring the capacitance or impedance of a material or an active NTC sensor). Consumable cartridges containing a consumable and designed to fit into a compartment in the consumable holder 30 can be provided with a barcode or an RFID tag. The sensors can be located within consumable holder 30 or a consumable reader 56 such as a barcode reader can be used in conjunction with the consumable holder 30. In this manner, the consumable can communicate with the appliance 10 either directly or through the consumable holder 30. A single sensor can be used to obtain information regarding the consumables in the consumable holder or more than one sensor can be used in combination to determine the presence and general nature of a consumable within one of the compartments 32-37. The information can also be entered manually by the user through either the appliance user interface 22 or through the consumable holder user interface 70.

The information from the sensors regarding the presence and general nature of the consumable can be communicated to the appliance 10 either directly or through the consumable process control apparatus 54 through the internal communications network 50. As discussed above, the software architecture provides an open network through which information from one or more components in the appliance can be used to perform an operation to complete a physical domestic operation on an article. The consumable holder 30 and the appliance 10 can function cooperatively to perform a cycle of operation using one or more appliance resources in combination with one or more consumables.

It will be apparent, then that the consumable holder is enabled to convey such information as the configuration of the compartments in the receptacle, the type of consumable in each compartment, the quantity of consumable in each compartment, when in the operational cycle to dispense the consumable, and the potency or concentration of the consumable, for example in terms of the volume to be dispensed. The latter may be important, for example, in a detergent dispenser for a small, medium, or large load. Each use can build a data set stored in memory that can later be accessed for reporting and/or assessing planned use of resources.

A sensor or sensors can be used to sense and determine the configuration of the compartments, mechanical features of the compartments, electrical parameters of the compartments, or optical parameters of the compartments. They can also be used to determine at least some information about the type, quantity, or dosing attributes of the consumable in one or more compartments. That sort of information can also be obtained from the user via the user interface 22. Information about the type, quality, and dosing attributes of the consumable can be used in conjunction with information about the specific cycle chosen. For example, it can be used with information about the type, size, or soil level of a wash load to optimize cycle parameters. Here, the information about the type, size, or soil level of the load can be determined during the cycle by the appliance control. RFID technology to determine various parameters such as the compartment configuration.

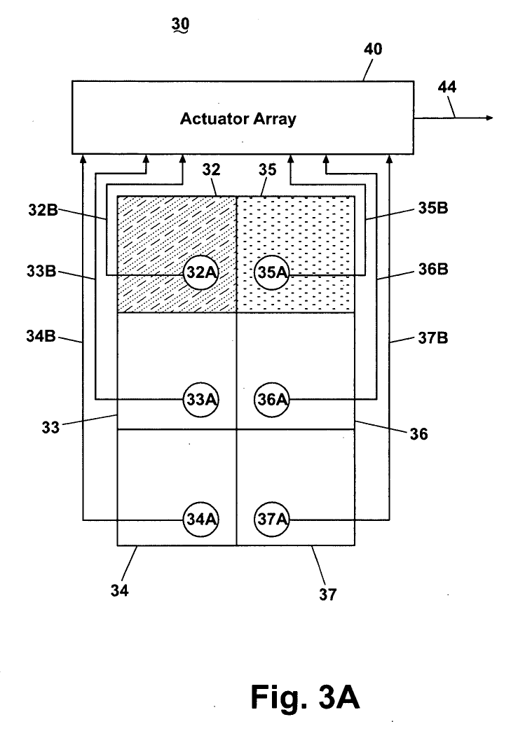

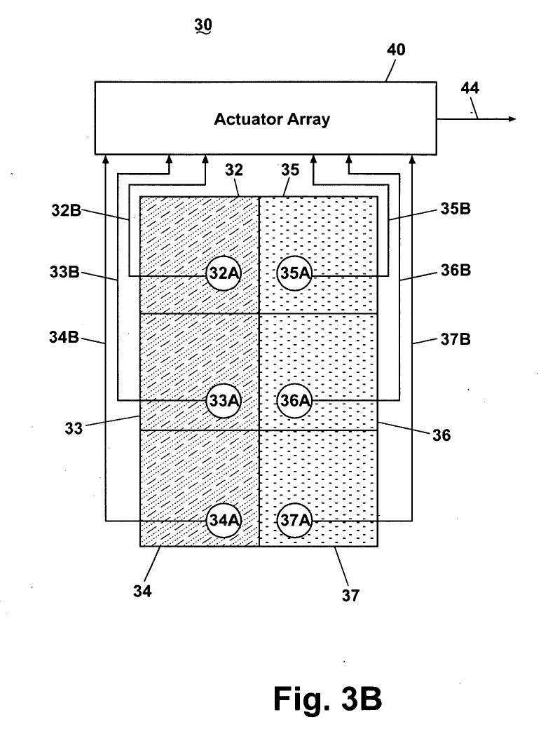

FIG. 3A illustrates an example of a consumable holder 30 configured for use in a washing machine. The consumable holder 30 is configured to contain a detergent in compartment 32 and a fabric softener in compartment 35. The consumable can be in the form of a cartridge designed to fit within the compartment and dock with the corresponding compartment port. The consumable can also be placed into a compartment by a user or by an external source, such as a conduit connected to an external reservoir. The cartridge can contain a bar code that can transmit information such as its presence, location and general nature, for example, as described above with reference to FIG. 2. Information regarding consumables not contained within a prepackaged container such as a cartridge can be provided by other types of optical, electrical or mechanical sensors. The information can be received by the consumable reader 54 each time the appliance 10 is used or it can be stored at the consumable process control apparatus 54 or the appliance process control apparatus 20. The controller 54 can communicate the information with the appliance 10 each time the appliance 10 is used or the appliance 10 can upload and store the information on the appliance process control apparatus 20. Other sensors present in the consumable holder 30 or consumable reader 56 can be used in addition to the bar code to obtain information about the consumables. In addition, the user can enter some or all of the information manually through the appliance user interface 22 or the consumable holder user interface 70.

The consumable holder 30 discovers the number, size and shape of the compartments through the discovery process and communicates this information with the consumable process control apparatus 54. The consumable process control apparatus uses this information to identify which actuators 42 to control in the actuator array 40. Still referring to FIG. 3A, the consumable process control apparatus 54 discovers that the consumable holder 30 comprises 6 different compartments 32-37, but that only two compartments, 32 and 35 contain consumables. The consumable process control apparatus 54 uses this information to identify which actuators to actuate to control the flow of consumables from compartments 32 and 35.

Once the consumable holder determines the configuration of the compartments, the general nature of the consumable in each of the compartments can be determined as described above. The appliance uses sensor data from sensors in the consumable holder or from a consumable reader to obtain information about the consumable complete a cycle of operation using one or more consumables.

It is also contemplated that the user can manually enter the information about the configuration of the consumable holder 30 and the nature of the consumables into the appliance 10. For example, a user interface can prompt the user to select a configuration from a list of limited options or select which port to use to access the consumable. The list of options can be in the form of text or images corresponding to each possible configuration. The user can then be prompted to enter information about the nature of the consumable, such as function, quantity, and brand name for example. The information can be entered by the user through the appliance user interface 22 or the consumable holder user interface 70.

The information about the configuration of the consumable holder and the nature of the consumables is then transmitted through the appliance communications network 50 to affect a cycle of operation of the appliance 10. Operating cycles can be preprogrammed into the appliance 10 prior to purchase or uploaded at a later date. Operating cycles can be uploaded to the appliance via the internet or through a hardware device that can plug into the appliance 10 or the consumable holder 30 (e.g. USB dongle), manually entered by the user, or be received from the consumable (e.g. from an RFID tag on a cartridge). Another manner of implementation is for the consumable to have an identifier and the appliance has a stored database or access to an external database or table of operating cycles for different consumables. The appliance 10 takes the consumable identifier and looks up the corresponding operating cycle for the consumable. Operating cycles can be automatically selected by the appliance 10 or selected manually by the user. The appliance 10 and/or the consumable holder 30 can recommend a cycle or cycles of operation based on the consumables sensed within the consumable holder. One or more of these methods can be combined to provide an operating cycle that contains all of the information required for the appliance 10 to complete a cycle of operation on a physical article using one or more consumables. As described above, software for storing information regarding the use of consumables and resources in a cycle of operation and modifying cycles of operation with information received regarding the consumables can be located on any node in the appliance communications network 50 and accessed by any other node on the network. Example nodes include, the consumable process control apparatus 54, the appliance process control apparatus 20 or an operational client in the consumable holder 30.

Once an operating cycle has been initiated, some or all of the components in the appliance 10 can communicate with the consumable process control apparatus 54 through the software architecture described above to complete a cycle of operation with one or more consumables. The consumable process control apparatus can communicate with individual components on the appliance communications network 50 or all of the information can be communicated through a main controller such as the appliance process control apparatus 20, for example.

Referring again to the example illustrated in FIG. 3A, at a predetermined point in the wash cycle, controller 54 actuates the actuator 46 that controls the flow of the consumable in the compartment 32, identified as a detergent, to the appliance 10 through the tube 32b. The consumable process control apparatus 54 can then actuate the actuator 46 that controls the flow of the consumable in the compartment 35, identified as the fabric softener, at the same time as it actuate the actuator 46 that controls the flow of the consumable in cartridge 60. The actuator 46 can also be actuated at a different point in the cycle. The actuator array 40 is able to open more than one actuator at any given time.

The amount of consumable delivered to the appliance 10 can be determined by several different methods. For example, the selected cycle of operation can include a generic detergent step whereby the amount added is the same for any consumable identified as a detergent. The appliance can also use the information provided by the consumable to determine the amount of detergent to add based on the information in a database or table of operating cycles for that specific detergent. The detergent specific information can be based on brand, type, concentration or other chemical or physical property such as pH or viscosity, for example. Detergent specific information can also be obtained by sensors within the consumable holder 30 or the appliance 10. For example, an index of refraction sensor can be used to determine the concentration of surfactant in the detergent and adjust the amount added during the wash cycle accordingly. Rather than looking up the information in a database or table, the consumable can supply the information directly to the appliance. For example, an RFID tag on a consumable cartridge can transfer information on how to use the consumable in a cycle of operation to the consumable process control apparatus 54. Another option is to use data from other sensors in the appliance, such as load size, to determine when enough of a consumable, such as detergent, has been added, for example.

The amount of consumable delivered to an appliance 10 can be controlled using several different methods. The amount of a consumable added can be controlled by adjusting the length of time an actuator 42 in the actuator array 40 is open. The length of time can be predetermined in the operating cycle based on the information provided by the consumable or on information received from sensor data. Parameters such as concentration, viscosity and flow rate of the consumable can be used to calculate how long the actuator 42 should remain open to achieve the desired concentration. The actuator 42 can also stay open until a predetermined condition is met, such as a desired pH, for example. The actuator array 40 can also include or be connected with one or more optional variable speed pumps 46 that can control the flow rate of a consumable from the consumable holder 30 to the appliance 10. The pumps 46 are configured to accurately control the volume of consumable dispensed independently of the fluid properties of the consumable. The pumps 46 can also be configured to provide information to be used in tracking the amount of consumable dispensed in each compartment. A measuring sensor can be provided in the fluid stream, for example, to measure the flow and to send a representative signal to a process control apparatus 22, 54 that is programmed to calculate the amount of consumable used. Similarly, the pumps 46 can be used to detect the presence or absence of fluid in the conduit. With appropriate messaging, the appliance process control apparatus 22 or the consumable process control apparatus 54 can be notified if the pump 46 detects a lack of consumable in the conduit, and take appropriate action.

Consumables can then be added at different rates to achieve the desired concentration or to meet predetermined condition. Consumables such as detergents that have a high concentration of surfactants can benefit from being added slowly to minimize excessive foaming.

While actuator array 40 is able to deliver the consumables in the consumable holder 30 in adjustable, measured quantities, it is contemplated that all of the consumable can be used at any given time.

The consumables holder 30 is also able to determine the quantity of the consumable in each of the compartments at any time and communicate this information to the user. The quantity of the consumable remaining in a compartment can be determined by determining the initial amount and monitoring the quantity dispensed. The initial amount of a consumable can be determined from sensor data or from information received from the consumable. Sensor data can also be used to determine the amount of a consumable remaining on a continuous basis or when requested by the user. Suitable sensor techniques for determining the amount of a consumable in a compartment include transmission/absorption spectroscopy, total internal reflectance spectroscopy, index of refraction, capacitance/impedance measurements and active NTC, for example. The consumable holder 30 can communicate the status of the consumables to the user, in terms of standard loads remaining, for example, through the appliance user interface 22 or through the consumable holder user interface 70.

The consumable holder 30 can communicate with the appliance through the internal communications network 50 to adjust and optimize the implementation of a cycle of operation that utilizes one or more consumables. Information received from the sensors in the appliance, such as the size of the load, the particulate or soil level or stain level (based on turbidity or conductivity measurements), or input from the user, such as the type or color of the load can be used to adjust or modify parameters within the selected cycle of operation prior to the initiation of the cycle or during the cycle. The appropriate amount and timing of administration of each of the consumables is then determined accordingly. Referring again to the example illustrated in FIG. 3A, if a sensor in a washing machine determines that a load still has high soil levels after the wash cycle, the actuator 42 controlling the flow of the consumable in compartment 32 can be opened and more detergent can be added and the wash cycle can be repeated. Information received from the consumables can also be used to adjust or modify the cycle of operation. In the case of the example just given, if it is determined that there is not enough detergent remaining in the consumable compartment 32, the cycle parameters can be adjusted to continue the first wash cycle for longer period of time or use a more aggressive tumble cycle.

It is also contemplated that if the consumable holder 30 determines that a compartment is empty or does not contain enough of a consumable to complete a cycle, it can look for other compartments that contain a consumable that performs the same or similar function. In the example configuration illustrated in FIG. 3A, if the consumable holder 30 determines that there is not enough detergent in compartment 32 to complete the cycle, the consumable holder 30 can use the discovery process to look for consumables in other compartments that function similar to the detergent in compartment 32. If the consumable holder identifies compartment 33 as containing a detergent, the consumable process control apparatus 54 can use this information to actuate the actuator controlling the flow of consumable from compartment 33 to complete the wash cycle. This discovery process can take place before the cycle of operation is initiated or at some point in time during the cycle of operation and be initiated automatically or by the user. The user can also manually identify a back-up consumable to be used in case a consumable in a compartment runs out during the course of a cycle of operation.

Another example of a possible configuration for the consumable holder 30 illustrated in FIG. 3B comprises placing a cartridge containing a detergent in each of the compartments 32, 33, and 34 and placing a cartridge containing a fabric softener in each of the compartments 35, 36, and 37. The consumable holder 30 completes the discovery process and determines the nature of the consumable in each compartment as described above. The consumable process control apparatus 54 can contain a software component that will automatically use the consumables in compartments 32-34 and 35-37 in series. When compartment 32 runs out, the consumable process control apparatus 54 will automatically actuate the actuator controlling the flow of the consumable in compartment 33 and so on. The user can also manually select this option from a menu in the appliance user interface 22 or the consumable holder user interface 30. The user can also be prompted with this option when the consumable holder 30 discovers more than one compartment containing the same or similar consumables.

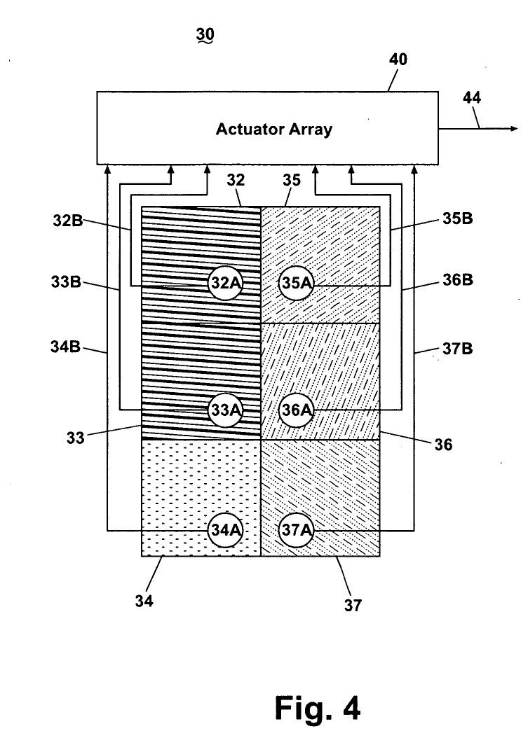

FIG. 4 illustrates an example of another possible configuration for a consumable holder 30 according to another embodiment of the invention. The consumables used with the consumable holder 30 need not necessarily all be the same type. For example, a consumable holder 30 for use in a water dispensing unit, such as is sometimes provided with a refrigerator, can contain a filter (an example of one type of consumable) for filtering water and water flavoring additives (an example of another type of consumable). As illustrated in FIG. 4, the consumable holder 30 is configured to comprise a water filter and four water flavoring cartridges. The water filter can comprise multiple filter units within multiple compartments or one large filter unit in a single, larger compartment, as shown. The consumable holder 30 is connected with a water delivery conduit connected with the refrigerator water dispenser device through a resource coupling point as described above with reference to FIG. 1. The actuator array 40 controls the dispensing of water from the consumable holder 30. Information regarding the configuration of the consumable holder 30 and the general nature of the consumables can be determined through the discovery process and sensor input, entered by the user or a combination of both methods.

The user can select a cycle of operation, in this example the cycle of operation is the dispensing of water, through the appliance user interface 22 or the consumable holder user interface 70. The actuator array 40 controls the dispensing of water that has been modified by one or more of the consumables in the consumable holder 30. For example, a user can select filtered water with a flavoring. The consumable process control apparatus 54 can actuate the relevant actuators 42 in the actuator array 40 independently to modify the water with both consumables. The consumable process control apparatus 54 can actuate the actuator controlling the flavoring additive to deliver the flavoring additive to the water at the same time it actuates the actuator controlling the flow of filtered water. Filter, flavored water is then dispensed to the user. The consumable process control apparatus 54 can also actuate the actuator controlling the flavoring additive to deliver the flavoring additive before or after the filtered water has been delivered. For example, the consumable process control apparatus 54 can actuate the actuator controlling the flavoring additive to deliver an aliquot of flavoring additive to a container supplied by the user or the appliance for receiving the water to be dispensed. The consumable process control apparatus 54 then closes the actuator to the flavoring additive and then actuates the actuator controlling the flow of filtered water to the container. This series of steps results in flavored, filtered water that can be dispensed to the user.

The consumable process control apparatus 54 can also actuate the actuator array 40 to selectively control the amount of a consumable used each time according to the desires of the user. For example, still referring to FIG. 4, the user can use the appliance user interface 22 or the consumable holder user interface 70 to select a cycle of operation to dispense flavored water of different flavoring strength or concentration. The consumable process control apparatus 54 activates the actuator corresponding to the selected flavoring consumable for different lengths of time depending on the strength chosen by the user. If the user requests strongly flavored water, the consumable process control apparatus 54 activates the corresponding actuator for a longer period of time than if the user had chosen less strongly flavored water (less concentrated).

When a cycle of operation is complete, the parts of the consumable holder between the consumable compartments and the conduit 52 are flushed with an appliance resource such as air or water to remove materials from the system to prevent reactions between incompatible consumables and clogging. The system flush can be initiated by a command from the consumable holder or the user or can be part of the cycle of operation.

While the invention has been described with a consumable holder comprising 1 to 6 compartments connected with 1 to 6 actuators in an actuator array, this is for illustrative purposes only. It is contemplated that the invention can include any number of compartments connected with any number of actuators in an actuator array.

While the invention has been described in connection with certain specific embodiments thereof, it can be understood that this is by way of illustration and not of limitation and the scope of the appended claims should be construed as broadly as the prior art will permit.

What is claimed is:

1. A consumable holder for an appliance configured to perform a cycle of operation on a physical article comprising:
a receptacle,
an array of actuators, each actuator controlling access to a conduit adapted to be in fluid communication with an appliance, and
a circuit adapted to connect to a process control apparatus to control activation of the actuators,
wherein the receptacle is sized to hold more than one compartment, each compartment being adapted to hold a consumable to be used in a cycle of operation and having a port to connect to a actuator in the actuator array, and wherein the controller can control the dispensing of a consumable from each compartment by actuating at least one actuator in the actuator array.

2. The consumable holder of claim 1 further comprising at least one pump for use in conjunction with the actuator array to dispense consumables to the appliance

3. The consumable holder in claim 2 wherein the at least one pump is enabled to accurately control the volume of consumable dispensed independently of the fluid properties of the consumable.

4. The consumable holder of claim 2 wherein the pump is enabled provide information to be used in tracking the amount of consumable dispensed in each compartment.

5. The consumable holder of claim 2 wherein the pump is enabled to detect the presence or absence of fluid in the conduit.

6. The consumable holder of claim 1 wherein the receptacle is adapted to hold compartments of different sizes or shapes.

7. The consumable holder of claim 2 where the configuration of the compartments can be altered by the appliance user.

8. The consumable holder of claim 2 wherein at least one of the compartments is enabled to hold and dispense a consumable for at least two cycles of operation.

9. The consumable holder of claim 2 wherein at least one of the compartments is configured to hold and dispense a liquid consumable.

10. The consumable holder of claim 1 wherein the compartment is enabled to received a cartridge.

11. The consumable holder of claim 1 further comprising a process control apparatus.

12. The consumable holder of claim 11 wherein process control apparatus is configured to dispense at least two consumables in any segment of an operation cycle.

13. The consumable holder of claim 11 further comprising at least one pump for use in conjunction with the actuator array to dispense consumables to the appliance and wherein the process control apparatus will be notified if the pump detects a lack of consumable.

14. The consumable holder of claim 11 configured to communicate over a network and convey information about itself or its contents.

15. The consumable holder of claim 14 wherein the information comprises one of the configuration of the compartments, the type of consumable in each compartment, the quantity of consumable in each compartment, when in the operational cycle to dispense the consumable, and the potency or concentration of the consumable.

16. The consumable holder of claim 15 wherein the process control apparatus uses the information to build and store a data set for later retrieval.

17. The consumable holder of claim 11 wherein the process control apparatus is configured to ascertain information about the consumables or the compartments and convey the information to the appliance to affect the cycle of operation.

18. The consumable holder of claim 5 further comprising at least one sensor to determine one of the mechanical features of the compartments, the compartment configuration, electrical parameters of the compartments, optical parameters of the compartments, and at least some information about the type, quantity, or dosing attributes of the consumable in one or more compartments.

19. The consumables holder of claim 18 wherein the sensor comprises an RFID chip.

20. The consumable holder of claim 18 wherein at least some of the information about the type, quantity, or dosing attributes of the consumable can be obtained from the user via the user interface.

21. The consumable holder of claim 18 wherein the information about the type, quality, and dosing attributes of the consumable can be used in conjunction with information about the specific cycle chosen and the type, size, or soil level of the load to optimize cycle parameters.

22. The consumable holder of claim 1 wherein the receptacle is configured to be removably coupled to an appliance.

23. The consumable holder of claim 22 wherein the receptacle and its components can be cleaned in a sink or dishwasher without adverse effects.

24. The consumable holder of claim 22 wherein the process control apparatus is in the appliance and is notified when the receptacle is removed or connected.

25. The consumable holder of claim 24 where the appliance process control apparatus is enabled to initiate a maintenance operation when notified that the receptacle has been removed.

26. The consumable holder of claim 14 wherein the information is discovered each time the receptacle has been removed or connected.

27. The consumable holder of claim 1 wherein the process control apparatus can discover the configuration of the compartments and identify the actuators to be controlled in the actuator array.

28. The consumable holder of claim of claim 27 wherein the process control apparatus is in communication with the appliance and directs the appliance to flush the conduits before, during, or after any dispensing.

29. The consumable holder of claim 1 further comprising a user interface.

30. An appliance configured to perform a cycle of operation on a physical article, the appliance comprising:
an array of actuators, each actuator controlling access to a conduit in fluid communication with a component in the appliance, and
a process control apparatus configured to control activation of the actuators,
a receptacle sized to hold more than one compartment, each compartment being adapted to hold a consumable to be used in a cycle of operation and having a port to connect to a actuator in the actuator array,
and wherein the process control apparatus can control the dispensing of a consumable from each compartment by actuating at least one actuator in the actuator array.

31. The appliance of claim 30 further comprising a user interface that can configure one of the user interface, the receptacle, and the process control apparatus.

32. The appliance of claim 31 wherein the process control apparatus uses discovery messages to one of configure itself, obtain information about the receptacle configuration, and obtain information about the consumables.

33. A consumable holder for an appliance configured to perform a cycle of operation on a physical article comprising:
a receptacle having more than one outlet port, each port adapted to connect to a actuator in a actuator array that controls access to a conduit adapted to be in fluid communication with an appliance,
wherein the receptacle is sized to hold more than one compartment, each compartment being adapted to hold a consumable to be used in a cycle of operation and having a port to connect to an outlet port.

34. The consumable holder of claim 33 wherein the receptacle is adapted to hold compartments of different sizes or shapes.

35. The consumable holder of claim 33 further comprising a process control apparatus.

36. The consumable holder of claim 35 configured to communicate over a network and convey information about itself or its contents.

37. The consumable holder of claim 35 wherein the process control apparatus is configured to ascertain information about the consumables or the compartments and convey the information to the appliance to affect the cycle of operation.

38. The consumable holder of claim 33 removably coupled to an appliance.

39. The consumable holder of claim 33 wherein the process control apparatus can discover the configuration of the compartments and identify the actuators to be controlled in the actuator array.

40. The consumable holder of claim 35 wherein the process control apparatus is in communication with the appliance and directs the appliance to flush the conduits after a consumable is changed in a compartment.

41. The consumable holder of claim 33 further comprising a user interface.

42. An appliance configured to perform a cycle of operation on a physical article, the appliance comprising:
a controller, and
a software component configured to cause the controller to alter a cycle of operation based on information it obtains about a connected accessory where the accessory is a configurable consumable holder.sd.
